(19) United States
(12) Patent Application Publication
(10) Pub. No.: US 2025/0242688 A1
(43) Pub. Date: Jul. 31, 2025

(54) WHEEL ASSEMBLY AND MOVABLE ELECTRONIC DEVICE

(71) Applicant: WISTRON CORP., New Taipei City (TW)

(72) Inventors: SSU CHIEH KAO, New Taipei City (TW); JIAN RONG LIAO, New Taipei City (TW); PO FAN CHENG, New Taipei City (TW)

(21) Appl. No.: 18/625,339

(22) Filed: Apr. 3, 2024

(30) Foreign Application Priority Data
Jan. 31, 2024 (TW) 113103754

(51) Int. Cl. B60K 17/356; B60K 23/08

(52) U.S. Cl. CPC B60K 17/356; B60K 2023/0858

(57) ABSTRACT

A wheel assembly includes a frame, at least one movable wheel and at least one guide wheel. The frame includes a seat portion and a support portion connected to each other. The movable wheel is rotatably disposed on the support portion, and the movable wheel has a first edge located opposite to the seat portion. The guide wheel is rotatably disposed on the support portion. The guide wheel has a second edge located opposite to the seat portion, and the second edge of the guide wheel is located closer to the seat portion than the first edge of the movable wheel.

### CROSS-REFERENCE TO RELATED APPLICATIONS

This non-provisional application claims priority under 35 U.S.C. § 119(a) on Patent Application No(s). 113103754 filed in Taiwan, R.O.C. on Jan. 31, 2024, the entire contents of which are hereby incorporated by reference.

### TECHNICAL FIELD

The disclosure relates a wheel assembly and a movable electronic device.

### BACKGROUND

Service robots, such as autonomous mobile robots or automated guided vehicles, may generally travel in a narrow environment, and thus they are designed to be small in size so as not to cause a sense of oppression.

In order to reduce the size of a service robot, it is necessary to reduce the size of its chassis, and a small chassis causes turning radii of driven wheels needs to be reduced so as not to interfere with surrounding components when turning. The turning radii of the driven wheels depend on its outer diameters and distances from its centers to turning axes of the driven wheels. Therefore, basically, the smaller the outer diameters of the driven wheels of the service robot have, the smaller size the service robot can be achieved. However, reducing the outer diameters of the driven wheels will make the contact points between the driven wheels and the obstacle close to the center of the driven wheels, which reduce the lifting force applied to the driven wheels. Accordingly, how to enable the driven wheels to have excellent ability to climb up the obstacle while having smaller diameters for achieving the size reduction of the service robot is one of crucial topics in this field.

### SUMMARY

The disclosure provides a wheel assembly and a movable electronic device which enable the driven wheels to have excellent ability to climb up the obstacle while having smaller diameters for achieving the size reduction of the service robot.

One embodiment of the disclosure provides a wheel assembly. The wheel assembly includes a frame, at least one movable wheel and at least one guide wheel. The frame includes a seat portion and a support portion connected to each other. The movable wheel is rotatably disposed on the support portion, and the movable wheel has a first edge located opposite to the seat portion. The guide wheel is rotatably disposed on the support portion. The guide wheel has a second edge located opposite to the seat portion, and the second edge of the guide wheel is located closer to the seat portion than the first edge of the movable wheel.

Another embodiment of the disclosure provides a movable electronic device. The movable electronic device includes a main body and a plurality of wheel assemblies. The wheel assemblies are respectively disposed at different positions of the main body and each include a frame, a movable wheel and a guide wheel. The frame includes a seat portion and a support portion connected to each other, and the seat portion is mounted on the main body. The movable wheel is rotatably disposed on the support portion, and the movable wheel has a first edge located opposite to the seat portion. The guide wheel is rotatably disposed on the support portion. The guide wheel has a second edge located opposite to the seat portion, and the second edge of the guide wheel is located closer to the seat portion than the first edge of the movable wheel.

Still another embodiment of the disclosure provides a movable electronic device. The movable electronic device includes a main body, a driving source, a driving wheel and a plurality of wheel assemblies. The driving source is disposed on the main body. The driving wheel is connected to the driving source. The wheel assemblies are respectively disposed at different positions of the main body and each include a frame, a movable wheel and a guide wheel. The frame includes a seat portion and a support portion connected to each other, and the seat portion is mounted on the main body. The movable wheel is rotatably disposed on the support portion, and the movable wheel has a first edge located opposite to the seat portion. The guide wheel is rotatably disposed on the support portion. The guide wheel has a second edge located opposite to the seat portion, and the second edge of the guide wheel is located closer to the seat portion than the first edge of the movable wheel. The driving source is configured to drive the driving wheel to move the main body so as to drive the wheel assemblies.

According to the wheel assembly and the movable electronic device, the guide wheel and the movable wheel are rotatably disposed on the support portion of the frame, and the second edge of the guide wheel is located closer to the seat portion of the frame than the first edge of the movable wheel, such that before the movable wheel contact the obstacle, the guide wheel can preliminarily contact the obstacle and lift the entire movable electronic device. Therefore, the movable wheel contacting the obstacle can obtain a greater lifting force so as to climb on the obstacle easily. As a result, the guide wheel enables the movable wheel to climb on the obstacle even the movable wheel has a small diameter due to the size reduction requirement of the movable electronic device.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a movable electronic device according to a first embodiment of the disclosure;

FIG. 2 is a perspective view of a wheel assembly in FIG. 1;

FIG. 3 is a side view of the wheel assembly in FIG. 2;

FIG. 4 is a bottom view of the wheel assembly in FIG. 2;

FIG. 5 is a side view of the movable electronic device in FIG. 1 when contacting an obstacle;

FIG. 6 is an enlarged view of a guide wheel of the wheel assembly in FIG. 5 when contacting the obstacle;

FIG. 7 is an enlarged view of a movable wheel of the wheel assembly in FIG. 6 when contacting the obstacle;

FIG. 8 is a curve chart showing a relationship between an outer diameter of the guide wheel in FIG. 2 and a ratio of a lifting force to a reverse force;

FIG. 9 is a side view of a wheel assembly according to a second embodiment of the disclosure;

FIG. 10 is a curve chart showing a relationship between an outer diameter of a guide wheel in FIG. 9 and a ratio of a lifting force to a reverse force;

FIG. 11 is a side view of a wheel assembly according to a third embodiment of the disclosure;

FIG. 12 is a curve chart showing a relationship between an outer diameter of a guide wheel in FIG. 11 and a ratio of a lifting force to a reverse force;

FIG. 13 is a perspective view of a wheel assembly according to a fourth embodiment of the disclosure; and

FIG. 14 is a perspective view of a wheel assembly according to a fifth embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

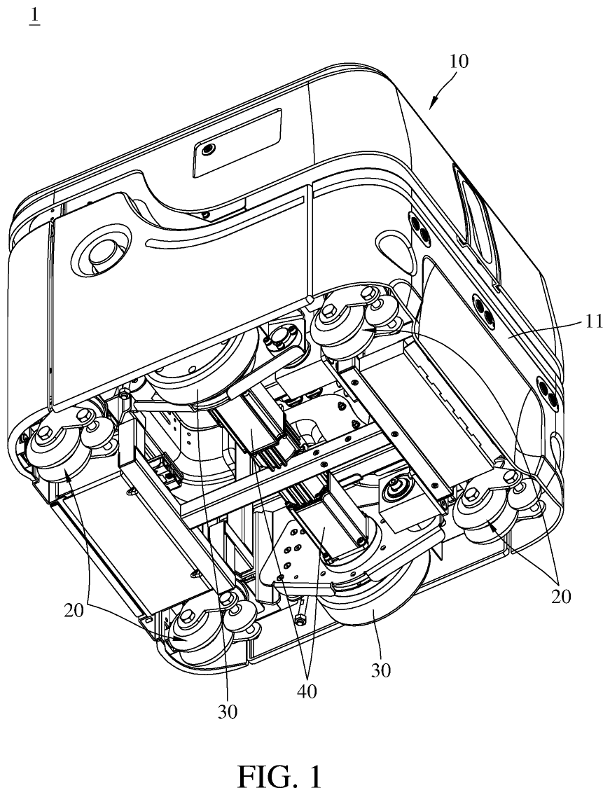

Referring to FIG. 1, FIG. 1 is a perspective view of a movable electronic device according to a first embodiment of the disclosure.

In this embodiment, the movable electronic device 1 is, for example, a server robot, such as an autonomous mobile robot or an automated guided vehicle. The movable electronic device 1 includes a main body 10 and a plurality of wheel assemblies 20. In addition, the movable electronic device 1 may further include a plurality of driving wheels 30 and a plurality of driving sources 40.

The main body 10 includes a casing 11 and a plurality of electronic components located in the casing 11, such as a circuit board, a battery and so on. The quantity of the wheel assemblies 20 is, for example but not limited to, four. The wheel assemblies 20 are respectively disposed at four corners of a bottom of the casing 11, and the wheel assemblies 20 are partially exposed to outside from the casing 11. The quantity of the driving wheels 30 is, for example but not limited to, two. One of the driving wheels 30 is located between two of the wheel assemblies 20, and the other one of the driving wheels 30 is located between the other two of the wheel assemblies 20. The driving sources 40 are, for example, motors, and the quantity thereof is, for example but not limited to, two. The driving sources 40 are disposed at the bottom of the casing 11, and are respectively connected to the two driving wheels 30 for driving the driving wheels 30 to rotate relative to the casing 11 and moving the entire movable electronic device 1. In one embodiment, the quantity of the driving source and the quantity of the driving wheel may be one, and the driving source and the driving wheel may be centrally disposed on the casing.

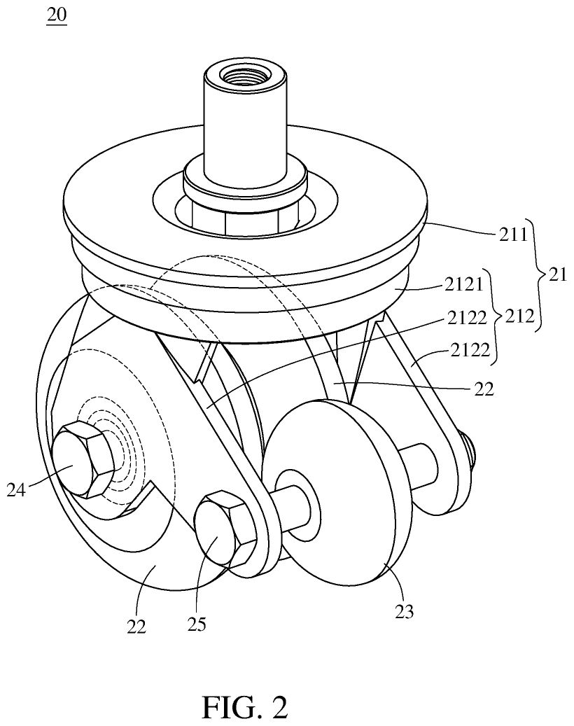

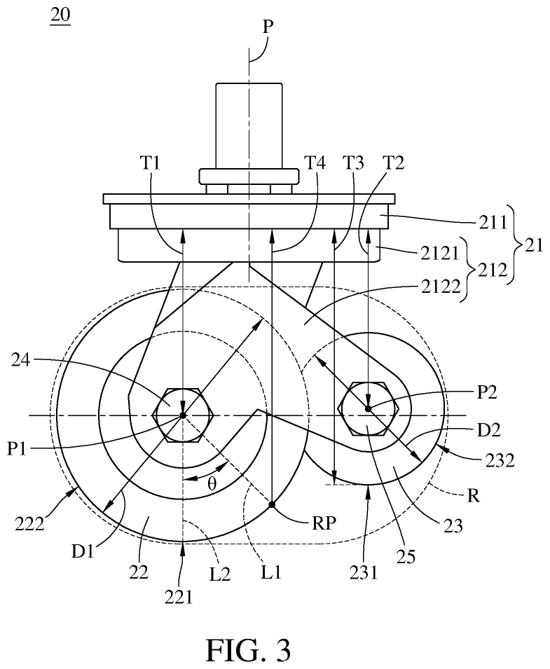

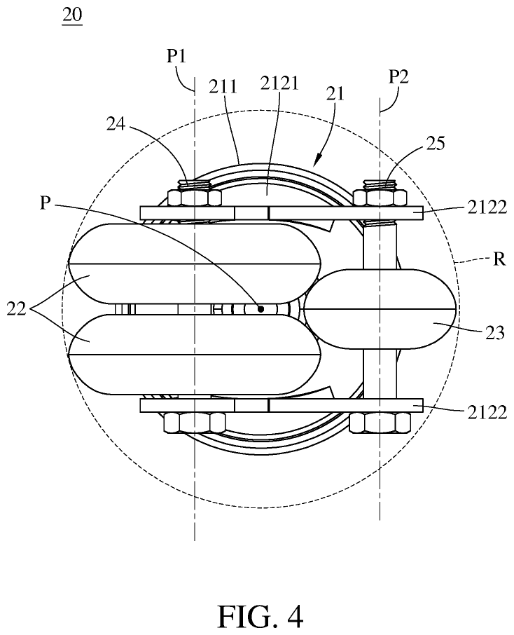

In this embodiment, the wheel assemblies 20 have the same structure, and thus the following paragraphs merely introduce one of the them specifically. Referring to FIGS. 1 to 4, FIG. 2 is a perspective view of a wheel assembly in FIG. 1, FIG. 3 is a side view of the wheel assembly in FIG. 2, and FIG. 4 is a bottom view of the wheel assembly in FIG. 2.

The wheel assembly 20 includes a frame 21, two movable wheels 22 and a guide wheel 23. In addition, the wheel assembly 20 may further include a first shaft 24 and a second shaft 25. The frame 21 includes a seat portion 211 and a support portion 212. The seat portion 211 is disposed in the casing 11. The support portion 212 includes a base 2121 and two arms 2122. The base 2121 of the support portion 212 is rotatably disposed on the seat portion 211. The two arms 2122 protrude from the base 2121 and are space apart from each other. The two movable wheels 22 are coaxially and rotatably disposed in between the two arms 2122 via the first shaft 24. The guide wheel 23 is rotatably disposed in between the two arms 2122 via the second shaft 25. A rotation axis P1 of the two movable wheels 22 (i.e., a central axis of the first shaft 24) and a rotation axis P2 of the guide wheel 23 (i.e., a central axis of the second shaft 25) are perpendicular to a rotation axis P of the base 2121 of the support portion 212 relative to the seat portion 211. The rotation axis P1 of the two movable wheels 22 is parallel to the rotation axis P2 of the guide wheel 23, the rotation axis P1 of the two movable wheels 22 are not overlapped with the rotation axis P2 of the guide wheel 23, and the rotation axis P1 of the guide wheel 23 is located closer to the seat portion 211 than the rotation axis P2 of the two movable wheels 22. In other words, a distance T2 from the rotation axis P2 of the guide wheel 23 to the seat portion 211 is smaller than a distance T1 from the rotation axis P1 of the movable wheels 22 to the seat portion 211.

In this embodiment, the guide wheel 23 is partially located between the movable wheels 22 and does not contact the movable wheels 22, and the guide wheel 23 is located in a rotation range R formed by the movable wheels 22 rotated relative to the seat portion 211 via the support portion 212. In a direction parallel to the rotation axis P1 of the movable wheels 22 (i.e., in a view angle of FIG. 3), the movable wheels 22 are partially overlapped with the guide wheel 23. In addition, outer diameters D1 of the movable wheels 22 are, for example but not limited to, greater than an outer diameter D2 of the guide wheel 23. Each of the movable wheels 22 has a first edge 221 located opposite to the seat portion 211. In each of the movable wheels 22, the first edge 221 is located at a position of an outer profile 222 of the movable wheel 22 located farthest away from the seat portion 211. The guide wheel 23 has a second edge 231 located opposite to the seat portion 211, and the second edge 231 is located at a position of an outer profile 232 of the guide wheel 23 located farthest away from the seat portion 211. The second edge 231 of the guide wheel 23 is located closer to the seat portion 211 than the first edges 221 of the movable wheels 22. A distance T3 from the second edge 231 of the guide wheel 23 to the seat portion 211 is greater than the distance T1 from the rotation axis P1 of the movable wheels 22 to the seat portion 211. In addition, a reference point RP is defined to be located at the outer profile 222 of the movable wheel 22, and the reference point RP is located farther away from the seat portion 211 than the rotation axis P1 of the movable wheel 22 and is located closer to the seat portion 211 than the first edge 221. A line L1 connected to the reference point RP and the rotation axis P1 of the movable wheel 22 is at an angle θ to a line L2 connected to the first edge 221 and the rotation axis P1 of the movable wheel 22, and the angle θ is about 45 degrees. The distance T3 from the second edge 231 of the guide wheel 23 to the seat portion 211 is smaller than a distance T4 from the reference point RP to the seat portion 211.

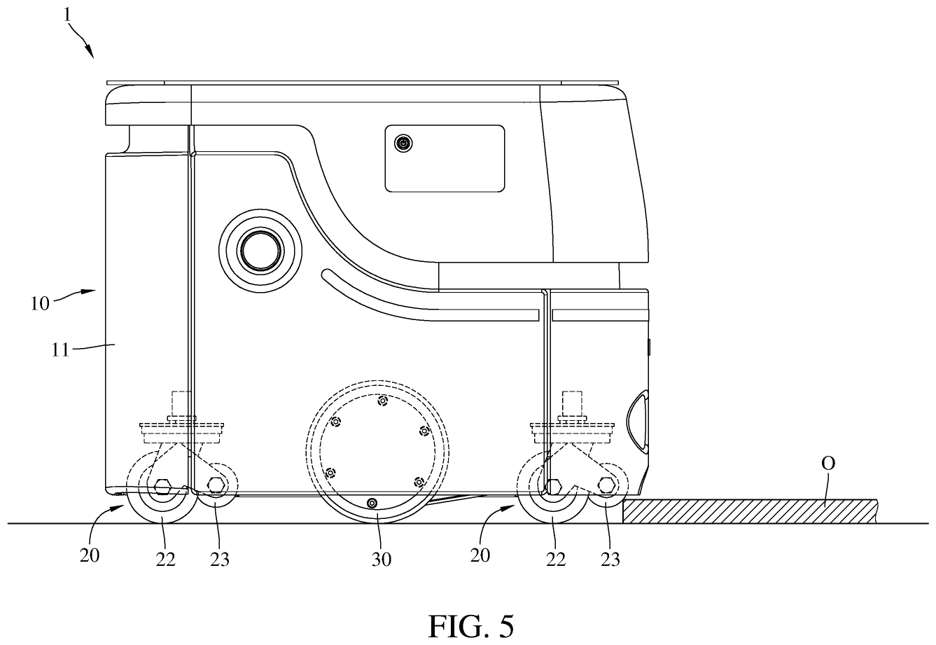

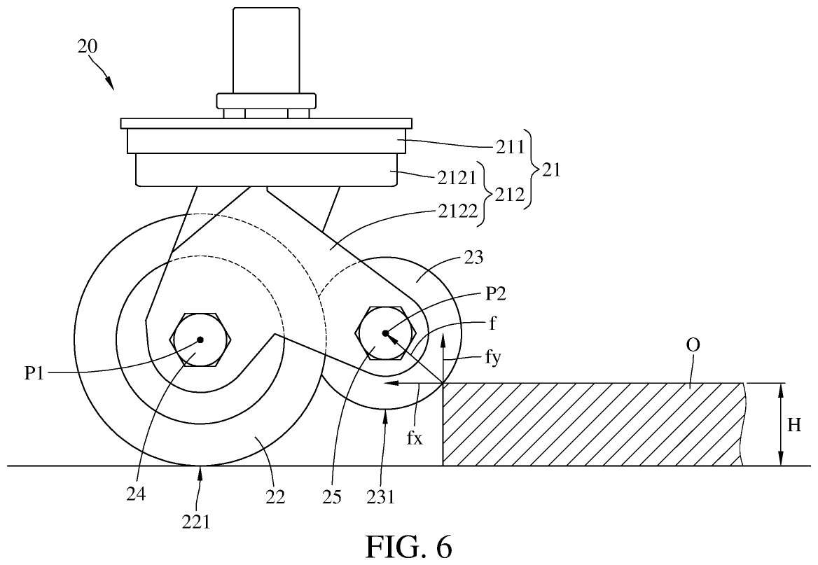

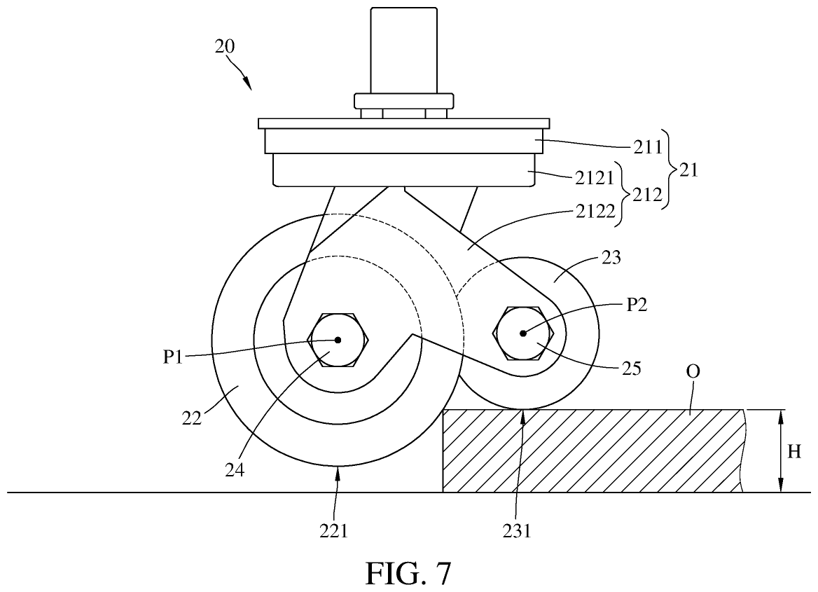

Then, referring to FIGS. 5 to 7, FIG. 5 is a side view of the movable electronic device in FIG. 1 when contacting an obstacle, FIG. 6 is an enlarged view of a guide wheel of the wheel assembly in FIG. 5 when contacting the obstacle, and FIG. 7 is an enlarged view of a movable wheel of the wheel assembly in FIG. 6 when contacting the obstacle.

When the movable electronic device 1 meets an obstacle O during travel, the guide wheel 23 of the wheel assembly 20 located at a front side of the movable electronic device 1 contacts the obstacle O earlier than the movable wheels 22. At this moment, an action force applied on the obstacle O by the guide wheel 23 produces a reaction force applied on the guide wheel 23, and this reaction force (e.g., represented by an arrow f) consists of a vertical lifting force (e.g., represented by an arrow fy) and a horizontal reverse force (e.g., represented by an arrow fx). During the operation of the driving sources 40 (e.g., shown in FIG. 1), the aforementioned lifting force lifts the entire movable electronic device 1 via the guidance of the guide wheel 23, such that the guide wheel 23 climbs on the obstacle O, and then the movable wheels 22 contact the obstacle O. As a result, the movable wheels 22 contacting the obstacle O can obtain a greater lifting force so as to climb on the obstacle O easily. Therefore, the guide wheel 23 enables the movable wheels 22 to climb on the obstacle O even the movable wheels 22 have small diameters due to the size reduction requirement of the movable electronic device 1.

In this embodiment, the distance T3 from the second edge 231 of the guide wheel 23 to the seat portion 211 is greater than the distance T1 from the rotation axis P1 of the movable wheels 22 to the seat portion 211, the distance T3 from the second edge 231 of the guide wheel 23 to the seat portion 211 is smaller than the distance T4 from the reference point RP to the seat portion 211, and the rotation axis P2 of the guide wheel 23 is located closer to the seat portion 211 than the rotation axis P1 of the movable wheels 22, which further enable the guide wheel 23 to help the movable wheels 22 to climb on the obstacle O more effectively.

Specifically, the wheel assembly 20 is additionally provided with the guide wheel 23, and thus there are two cases required to be analyzed, where one is the case that the guide wheel 23 contacts the obstacle O (e.g., shown in FIG. 6), and the other is the case that the movable wheels 22 contact the obstacle O (e.g., shown in FIG. 7). Regarding to the case that the guide wheel 23 contacts the obstacle O, assuming that the maximum action force that the driving sources 40 provide to move the entire movable electronic device 1 while not skidding is “F”, the outer diameters D1 of the movable wheels 22 are 38.1 mm, a height H of the obstacle O is 25 mm, a difference between the distance T2 from the rotation axis P2 of the guide wheel 23 to the seat portion 211 and the distance T1 from the rotation axis P1 of the movable wheels 22 to the seat portion 211 is 4 mm, and the diameter D2 of the guide wheel 23 is “r”, the lifting force applied to the guide wheel 23 can be obtained from the equation,

$$\frac{( 38.1 + 4 ) - 25}{\sqrt{{r}^{2} - {[ ( 38.1 + 4 ) - 25 ]}^{2}}} F = \frac{17.1}{\sqrt{{r}^{2} - {17.1}^{2}}} F .$$

Therefore, it can be understood that the smaller outer diameter D2 the guide wheel 23 has, the greater lifting force the guide wheel 23 obtains. On the other hand, as for the case that the movable wheels 22 contact the obstacle O, the guide wheel 23 can preliminarily lift the entire movable electronic device 1 a height which can be obtained from the equation, (r−4)+25−38.1=r−17.1, and thus the lifting force applied on the movable wheels 22 after the assistance of the guide wheel 23 can be obtained from the equation,

$$\frac{38.1 - 25 + ( r - 17.1 )}{\sqrt{38. {1}^{2} - {( 38.1 - 25 + ( r - 17.1 ) )}^{2}}} F = \frac{r - 4}{\sqrt{38. {1}^{2} - {( r - 4 )}^{2}}} F .$$

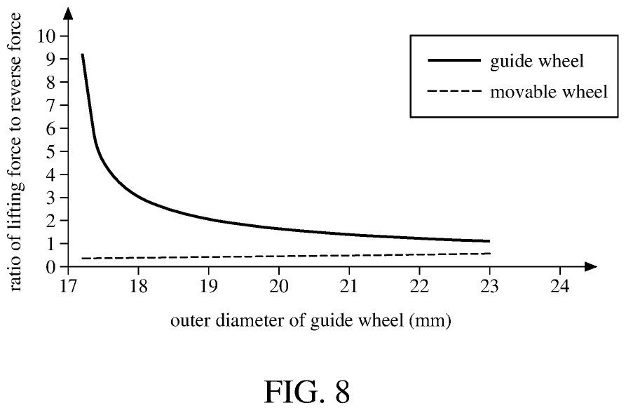

Therefore, it can be understood that the effect that the guide wheel 23 obtains the lifting force is opposite to the effect that the movable wheels 22 obtain the lifting force after the assistance of the guide wheel 23. In other words, the lifting force obtained by the guide wheel 23 may increase as the outer diameter D2 of the guide wheel 23 decreases; the lifting force obtained by the movable wheels 22 after the assistance of the guide wheel 23 may increase as the outer diameter D2 of the guide wheel 23 increases, where the aforementioned relationships can be seen from FIG. 8, and FIG. 8 is a curve chart showing a relationship between an outer diameter of the guide wheel in FIG. 2 and a ratio of a lifting force to a reverse force. As shown in FIG. 8, two lines illustrating the aforementioned relationships do not intersect each other, and thus the design of the wheel assembly 20 mainly considers the lifting force obtained by the movable wheels 22 after the assistance of the guide wheel 23; that is, during the design of the wheel assembly 20, the outer diameter D2 of the guide wheel 23 is required to be large as possible. Assuming the outer diameter D2 is set to be 23 mm in maximum in the case that the guide wheel 23 does not exceed the rotation range R formed by the movable wheels 22 rotated relative to the seat portion 211 via the support portion 212, the lifting force obtained by the movable wheels 22 may be up to about 0.58 F. As a result, compared to a case that two movable wheels of a wheel assembly without the guide wheel obtain the lifting force of 0.37 F which is calculated from the equation,

$$\frac{38.1 - 25}{38. {1}^{2} - {( 38.1 - 25 )}^{2}} F ,$$

the lifting force obtained by the movable wheels 22 with the assistance of the guide wheel 23 can be improved about 55%.

In this embodiment, the guide wheel 23 is located in the rotation range R formed by the movable wheels 22 rotated relative to the seat portion 211 via the support portion 212, which can prevent the guide wheel 23 from interfering with components located around the guide wheel 23. Note that the guide wheel may be partially located outside the range formed by the movable wheels rotated relative to the seat portion via the support portion when the aforementioned issue does not happen.

On other hand, in the direction parallel to the rotation axis P1 of the movable wheels 22, the movable wheels 22 are not restricted to being partially overlapped with the guide wheel 23. In some other embodiments, in the direction parallel to the rotation axis of the movable wheels, the movable wheels may not be overlapped with the guide wheel.

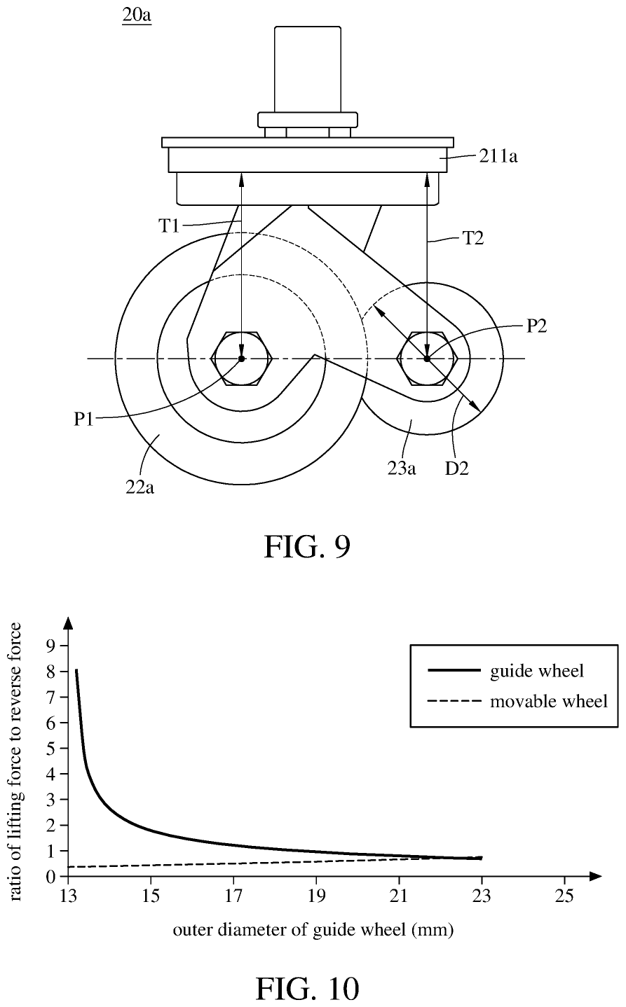

Then, referring to FIGS. 9 and 10, FIG. 9 is a side view of a wheel assembly according to a second embodiment of the disclosure, and FIG. 10 is a curve chart showing a relationship between an outer diameter of a guide wheel in FIG. 9 and a ratio of a lifting force to a reverse force.

The wheel assembly 20a of this embodiment is similar to the wheel assembly 20 of the previous embodiment, and the main difference between them is the position of the guide wheel. Therefore, the following paragraph mainly introduces such difference, and the same part between them will not be repeatedly introduced hereinafter.

In this embodiment, rotation axis P1 of movable wheels 22a is not located closer to or farther away from a seat portion 211a than a rotation axis P2 of a guide wheel 23a; that is, a distance T2 from the rotation axis P2 of the guide wheel 23a to the seat portion 211a is equal to a distance T1 from the rotation axis P1 of the movable wheels 22a. In such configuration, assuming other parameters are the same as that of the previous embodiment, the relationship between the lifting force obtained by the guide wheel 23a and an outer diameter D2 of the guide wheel 23a and the relationship between the lifting force obtained by the movable wheels 22a after the assistance of the guide wheel 23a and the outer diameter D2 of the guide wheel 23a can be seen from FIG. 10. As shown in FIG. 10, two lines illustrating the aforementioned relationships intersect each other at a position corresponding to the outer diameter D2 of the guide wheel 23a as 22.4 mm. In the case that the outer diameter D2 of the guide wheel 23a is 22.4 mm, the lifting force obtained by the movable wheels 22a may be up to about 0.72 F. As a result, compared to a case that movable wheels of a wheel assembly without the guide wheel obtain the lifting force of 0.37 F, the lifting force obtained by the movable wheels 22a with the assistance of the guide wheel 23a can be improved about 95%.

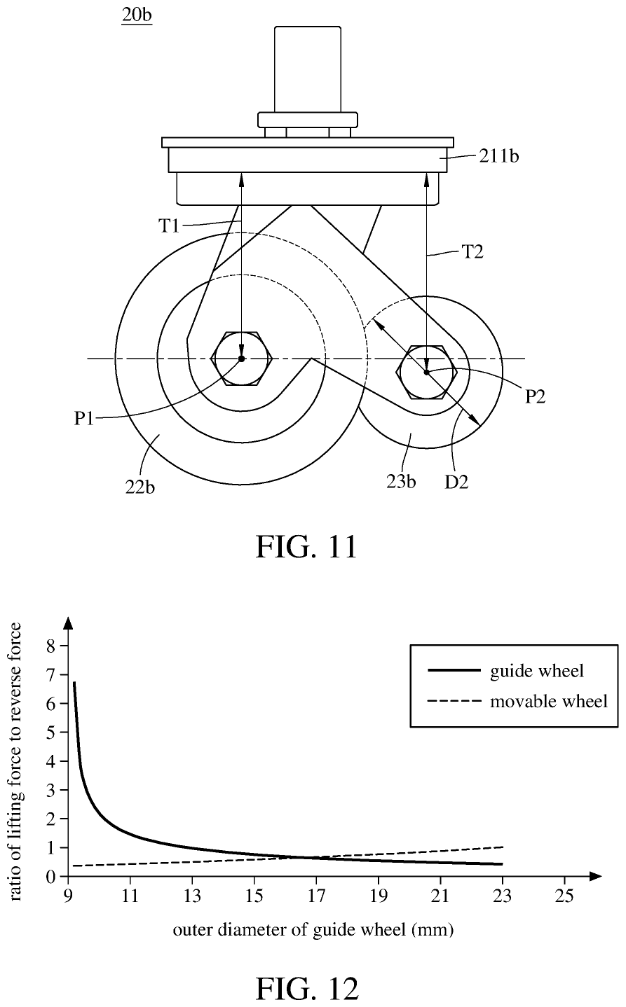

Then, referring to FIGS. 11 and 12, FIG. 11 is a side view of a wheel assembly according to a third embodiment of the disclosure, and FIG. 12 is a curve chart showing a relationship between an outer diameter of a guide wheel in FIG. 11 and a ratio of a lifting force to a reverse force.

The wheel assembly 20b of this embodiment is similar to the wheel assembly 20 of the previous embodiment, and the main difference between them is the position of the guide wheel. Therefore, the following paragraph mainly introduces such difference, and the same part between them will not be repeatedly introduced hereinafter.

In this embodiment, a rotation axis P2 of a guide wheel 23b is located farther away from a seat portion 211b than a rotation axis P1 of movable wheels 22b. A distance T2 from the rotation axis P2 of the guide wheel 23 is greater than a distance T1 from the rotation axis P1 of the movable wheels 22 to seat portion 211. In such configuration, assuming that the difference between the distance T2 from the rotation axis P2 of the guide wheel 23b to the seat portion 211a and the distance T1 from the rotation axis P1 of the movable wheels 22b to the seat portion 211a is 4 mm, and other parameters are the same as that of the previous embodiment, the relationship between the lifting force obtained by the guide wheel 23b and an outer diameter D2 of the guide wheel 23b and the relationship between the lifting force obtained by the movable wheels 22b after the assistance of the guide wheel 23b and the outer diameter D2 of the guide wheel 23b can be seen from FIG. 12. As shown in FIG. 12, two lines illustrating the aforementioned relationships intersect each other at a position corresponding to the outer diameter D2 of the guide wheel 23b as 16.8 mm. In the case that the outer diameter D2 of the guide wheel 23b is 16.8 mm, the lifting force obtained by the movable wheels 22b may be up to about 0.64 F. As a result, compared to a case that movable wheels of a wheel assembly without the guide wheel obtain the lifting force of 0.37 F, the lifting force obtained by the movable wheels 22b with the assistance of the guide wheel 23b can be improved about 73%.

In the aforementioned embodiments, the outer diameters of the guide wheels in the cases shown in FIGS. 3, 9 and 11 are set to be 23 mm, 22.4 mm and 16.8 mm, respectively. Therefore, it can be understood that the distance from the rotation axis of the guide wheel to the seat portion and the outer diameter of the guide wheel is in a negative correlation. In other words, during the design of the guide wheel, as the guide wheel is located farther away from the seat portion, the outer diameter of the guide wheel is set to be smaller.

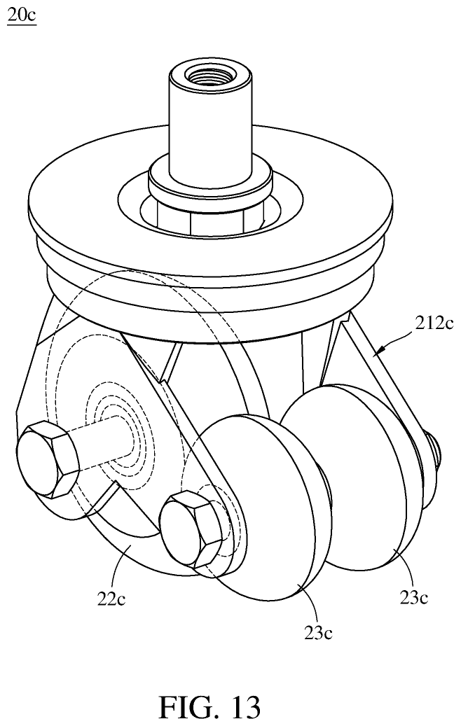

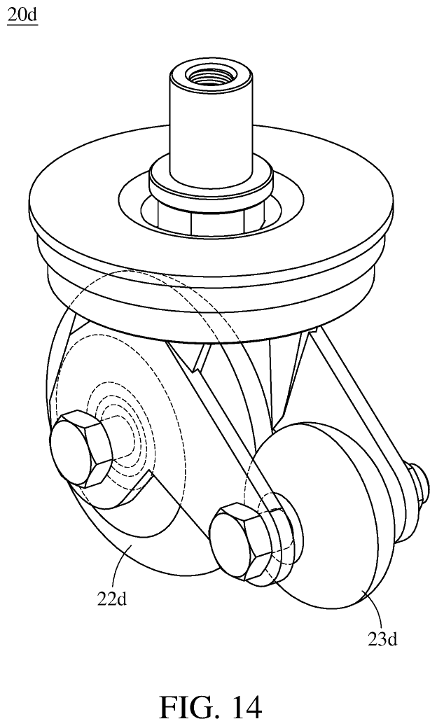

Then, referring to FIG. 13, FIG. 13 is a perspective view of a wheel assembly according to a fourth embodiment of the disclosure.

The wheel assembly 20c of this embodiment is similar to the wheel assembly 20 of the previous embodiment, and the main difference between them is the quantities of the movable wheel and the guide wheel. Therefore, the following paragraph mainly introduces such difference, and the same part between them will not be repeatedly introduced hereinafter.

In this embodiment, the wheel assembly 20c include one movable wheel 22c and two guide wheels 23c. The guide wheels 23c are coaxially and rotatably disposed on a support portion 212c, and the movable wheel 22c is partially located between the two guide wheels 23c.

Then, referring to FIG. 14, FIG. 14 is a perspective view of a wheel assembly according to a fifth embodiment of the disclosure.

The wheel assembly 20d of this embodiment is similar to the wheel assembly 20 of the previous embodiment, and the main difference between them is the quantities of the movable wheel and the guide wheel. Therefore, the following paragraph mainly introduces such difference, and the same part between them will not be repeatedly introduced hereinafter.

In this embodiment, the wheel assembly 20d include only one movable wheel 22d and only one guide wheels 23d.

According to the wheel assemblies and the movable electronic device, the guide wheel and the movable wheel are rotatably disposed on the support portion of the frame, and the second edge of the guide wheel is located closer to the seat portion of the frame than the first edge of the movable wheel, such that before the movable wheel contact the obstacle, the guide wheel can preliminarily contact the obstacle and lift the entire movable electronic device. Therefore, the movable wheel contacting the obstacle can obtain a greater lifting force so as to climb on the obstacle easily. As a result, the guide wheel enables the movable wheel to climb on the obstacle even the movable wheel has a small diameter due to the size reduction requirement of the movable electronic device.

In addition, the guide wheel is located in the rotation range R formed by the movable wheel rotated relative to the seat portion via the support portion, which can prevent the guide wheel from interfering with components located around the guide wheel.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A wheel assembly, comprising:
a frame, comprising a seat portion and a support portion connected to each other;
at least one movable wheel, rotatably disposed on the support portion, wherein the at least one movable wheel has a first edge located opposite to the seat portion; and
at least one guide wheel, rotatably disposed on the support portion, wherein the at least one guide wheel has a second edge located opposite to the seat portion, and the second edge of the at least one guide wheel is located closer to the seat portion than the first edge of the at least one movable wheel.

2. The wheel assembly according to claim 1, wherein a distance from the second edge of the at least one guide wheel to the seat portion is greater than a distance from a rotation axis of the at least one movable wheel to the seat portion.

3. The wheel assembly according to claim 2, wherein a rotation axis of the at least one guide wheel is located closer to the seat portion than the rotation axis of the at least one movable wheel.

4. The wheel assembly according to claim 2, wherein the distance from the rotation axis of the at least one movable wheel to the seat portion is substantially equal to a distance from a rotation axis of the at least one guide wheel to the seat portion.

5. The wheel assembly according to claim 2, wherein a rotation axis of the at least one guide wheel is located farther away from the seat portion than the rotation axis of the at least one movable wheel.

6. The wheel assembly according to claim 2, wherein the at least one movable wheel has an outer profile, the first edge is located at a position of the outer profile where is located farthest from the seat portion, a reference point is defined to be located at the outer profile, the reference point is located farther away from the seat portion than the rotation axis of the at least one movable wheel and is located closer to the seat portion than the first edge, a line connected to the reference point and the rotation axis of the at least one movable wheel is at an angle to a line connected to the first edge and the rotation axis of the at least one movable wheel, the angle is substantially 45 degrees, and the distance from the second edge of the at least one guide wheel to the seat portion is smaller than a distance from the reference point to the seat portion.

7. The wheel assembly according to claim 1, wherein a rotation axis of the at least one movable wheel is parallel to a rotation axis of the at least one guide wheel, and the rotation axis of the at least one movable wheel is not overlapped with the rotation axis of the at least one guide wheel.

8. The wheel assembly according to claim 7, wherein in a direction parallel to the rotation axis of the at least one movable wheel, the at least one movable wheel is partially overlapped with the at least one guide wheel.

9. The wheel assembly according to claim 1, wherein the at least one movable wheel comprises two movable wheels, the two movable wheels are coaxially and rotatably disposed on the support portion, and the at least one guide wheel is partially located between the two movable wheels.

10. The wheel assembly according to claim 1, wherein the at least one guide wheel comprises two guide wheels, the two guide wheels are coaxially and rotatably disposed on the support portion, and the at least one movable wheel is partially located between the two guide wheels.

11. The wheel assembly according to claim 1, wherein an outer diameter of the at least one movable wheel is greater than an outer diameter of the at least one guide wheel.

12. A movable electronic device, comprising:
a main body; and
a plurality of wheel assemblies, respectively disposed at different positions of the main body and each comprising:
a frame, comprising a seat portion and a support portion connected to each other, wherein the seat portion is mounted on the main body;
a movable wheel, rotatably disposed on the support portion, wherein the movable wheel has a first edge located opposite to the seat portion; and
a guide wheel, rotatably disposed on the support portion, wherein the guide wheel has a second edge located opposite to the seat portion, and the second edge of the guide wheel is located closer to the seat portion than the first edge of the movable wheel.

13. The movable electronic device according to claim 12, wherein the support portion is rotatably disposed on the seat portion, and the guide wheel is located in a rotation range formed by the movable wheel rotated relative to the seat portion via the support portion.

14. The movable electronic device according to claim 12, further comprising a plurality of driving wheels and a plurality of driving sources, wherein the plurality of driving wheels are rotatably disposed on different positions of the main body, and the plurality of driving sources are disposed on the main body and are respectively connected to the plurality of driving wheels.

15. The movable electronic device according to claim 14, wherein the quantity of the plurality of driving wheels and the quantity of the plurality of driving sources are two, the quantity of the plurality of wheel assemblies is four, the four wheel assemblies are respectively disposed at four corners of the main body, the two driving wheels are located opposite to each other, one of the two driving wheels is located between two of the four wheel assemblies, and the other one of the two driving wheels is located between the other two of the four wheel assemblies.

16. The movable electronic device according to claim 12, wherein a distance from the second edge of the guide wheel to the seat portion is greater than a distance from a rotation axis of the movable wheel to the seat portion.

17. The movable electronic device according to claim 16, wherein a rotation axis of the guide wheel is located closer to the seat portion than the rotation axis of the movable wheel.

18. The movable electronic device according to claim 16, wherein the distance from the rotation axis of the movable wheel to the seat portion is substantially equal to a distance from a rotation axis of the guide wheel to the seat portion.

19. The movable electronic device according to claim 16, wherein a rotation axis of the guide wheel is located farther away from the seat portion than the rotation axis of the movable wheel.

20. A movable electronic device, comprising:
a main body;
a driving source, disposed on the main body;
a driving wheel, connected to the driving source; and
a plurality of wheel assemblies, respectively disposed at different positions of the main body and each comprising:
a frame, comprising a seat portion and a support portion connected to each other, wherein the seat portion is mounted on the main body;
a movable wheel, rotatably disposed on the support portion, wherein the movable wheel has a first edge located opposite to the seat portion; and
a guide wheel, rotatably disposed on the support portion, wherein the guide wheel has a second edge located opposite to the seat portion, and the second edge of the guide wheel is located closer to the seat portion than the first edge of the movable wheel;
wherein the driving source is configured to drive the driving wheel to move the main body so as to drive the plurality of wheel assemblies.
